(19) United States
(12) Patent Application Publication
(10) Pub. No.: US 2020/0193855 A1
(43) Pub. Date: Jun. 18, 2020

(54) Virtual Reality High-Altitude Flight Experience Device with Centrifugal Weight System

(71) Applicant: Hoi Chun LAI, Hong Kong (HK)

(72) Inventor: Hoi Chun LAI, Hong Kong (HK)

(21) Appl. No.: 16/239,507

(22) Filed: Jan. 3, 2019

(30) Foreign Application Priority Data
Dec. 17, 2018 (CN) 201811539833.X

(51) Int. Cl. G09B 9/30; G09B 9/20; G09B 9/14

(52) U.S. Cl. CPC G09B 9/307; G09B 9/14; G09B 9/20

(57) ABSTRACT

The invention relates to a virtual reality high-altitude flight experience device with centrifugal weight system which includes a base, a balance steering device and a safety seat. The base includes a bottom plate, a steering seat, an annular cover plate and a steering rod. The balance steering device includes a cylinder composed of two curved plates, an end cover, a second hydraulic cylinder, a weight, a baffle, a bearing, a rotating shaft, a third hydraulic cylinder and a controller. The safety seat includes a back plate, a horizontal plate, a bumper and a VR helmet. The virtual reality high-altitude flight experience device with centrifugal weight system of the present invention has simple and reasonable structure, easy to operate, low cost, safe and reliable, strong sense of reality, and high degree of intelligence, etc. which effectively solves the problem of poor experience in the existing flight experience devices.

### FIELD OF THE INVENTION

The invention relates to the field of amusement equipment, in particular to a virtual reality high-altitude flight experience device with centrifugal weight system.

### BACKGROUND

In the known technology, driving a spacecraft or an aircraft is two important means to achieve human flight, but driving an aerospace vehicle needs to have good physical and psychological qualities. Obviously not everyone can meet such requirement. In addition, driving aerospace vehicles also need to undergo arduous and rigorous training. In the aerospace vehicles driving training and the actual driving, the risk factor is too high and it is very dangerous. Even if all the above requirements are met, the spacecraft and aircraft are expensive and the state puts them under surveillance. Most people can only experience flying by airplane or from the game, and the flight experience generated by airplanes and games obviously has great limitations, so it is necessary to develop a flight experience device which is easy to operate, safe and reliable, and provides realistic experience.

### SUMMARY OF THE INVENTION

The technical problem to be solved is to overcome the above-mentioned deficiency by providing a virtual reality high-altitude flight experience device with centrifugal weight system which has simple and reasonable structure, easy to operate, low cost, safe and reliable, strong sense of reality, and high degree of intelligence, etc. which effectively solves the problem of poor experience in the existing flight experience devices.

The technical solution of the present invention is to provide a virtual reality high-altitude flight experience device with centrifugal weight system which includes a base, a balance steering device and a safety seat. The base includes a bottom plate, a steering seat, an annular cover plate and a steering rod. The steering seat is a hollow structure with a bidirectional opening, and the opening of the steering seat facing downward is fixedly connected to the bottom plate. The opening of the steering seat facing upward is fixedly connected to the annular cover plate.

The steering rod has a hollow structure. The lower end of the steering rod passes through the annular cover plate and is provided with a convex ring laterally extended. The convex ring, the steering seat and the annular cover plate are respectively provided with semi-circular grooves. Balls are disposed on the semi-circular grooves. A steering motor is arranged in the inner cavity of the steering rod, and an output shaft of the steering motor is fixedly connected to the bottom plate. A connecting plate is fixedly arranged on the upper end of the steering rod, and a plurality of first hydraulic cylinders are hingedly disposed on the connecting plate.

The balance steering device includes a cylinder composed of two curved plates. The cylinder is connected to the steering rod through the first hydraulic cylinder. Two ends of the cylinder are respectively fixedly connected to and provided with an end cover. One end of the inner cavity of the cylinder is provided with a plurality of second hydraulic cylinders along the axial direction of the cylinder.

The output end of the second hydraulic cylinder passes through the end cover and is connected to the weight.

The other end of the inner cavity of the cylinder is fixedly provided with a baffle. The baffle and the end cover at this end are provided with bearings rotatably connected with a rotating shaft. The rotating shaft is connected to the baffle by a plurality of third hydraulic cylinders radially arranged. A controller is arranged in a middle portion of the inner cavity of the cylinder.

The safety seat includes a back plate, a horizontal plate, a bumper and a VR helmet. The back plate and the rotating shaft are fixedly connected to each other. The lower end of the back plate is connected to the horizontal plate through a connecting shaft, and the bumper is disposed on the back plate.

Further, the outside surface of one end of the cylinder facing the steering rod is a plane. The first hydraulic cylinders are respectively connected to points on the plane in two axial directions and in two radial directions of the cylinder.

Further, the two ends of the third hydraulic cylinder are respectively hinged with the rotating shaft and the baffle, and restrict the movement of the third hydraulic cylinder in the axial direction of the cylinder.

Further, the lower end of the back plate is slidably connected to the horizontal plate through the connecting shaft, and the connecting shaft passes through the horizontal plate and is sleeved with a pressure sensor and fixed by a nut.

Further, the weight is provided with a distance sensor for detecting the distance from the end cover, and an infrared proximity sensor is disposed on the end surface of the weight facing the moving direction of the second hydraulic cylinder.

The technical effect of the present invention is to provide a virtual reality high-altitude flight experience device with centrifugal weight system which includes a base, a balance steering device and a safety seat. The base provides support for the balance steering device and the safety seat, and meanwhile the balance steering device and the safety seat can be rotated along the horizontal plane driven by the steering motor. The first hydraulic cylinder drives the balance steering device to swing, and the third hydraulic cylinder drives the safety seat to rotate on a vertical plane. The safety seat combines the body weight data detected by the pressure sensor during the horizontal plane rotation. The weight disposed on the balance steering device can extend and contract to change the length extending outward to prevent the overturning and the damage to the base caused by centrifugal phenomenon. The VR helmet plays the corresponding picture and sound by detecting the user's position while matching the controller's preset program. It has simple and reasonable structure, easy to operate, low cost, safe and reliable, strong sense of reality, and high degree of intelligence, etc. which effectively solves the problem of poor experience in the existing flight experience devices.

### BRIEF DESCRIPTION OF THE DRAWINGS

The invention is illustrated by the following figures and embodiments.

FIG. 1 shows a schematic diagram of whole structure of a virtual reality high-altitude flight experience device with centrifugal weight system.

FIG. 2 shows a schematic diagram of inside structure of a base of a virtual reality high-altitude flight experience device with centrifugal weight system.

FIG. 3 shows a schematic diagram of a balance steering device of a virtual reality high-altitude flight experience device with centrifugal weight system.

FIG. 4 shows a schematic diagram of connection of a cylinder and a base of a virtual reality high-altitude flight experience device with centrifugal weight system.

FIG. 5 shows a schematic diagram of a rotating shaft and a third hydraulic cylinder of a virtual reality high-altitude flight experience device with centrifugal weight system.

FIG. 6 shows a schematic diagram of connection of a back plate and a horizontal plate of a virtual reality high-altitude flight experience device with centrifugal weight system.

The reference numbers of the figures are as follows:
1: base; 11: bottom plate; 12: steering seat; 13: annular cover plate; 14: steering rod; 141: convex ring; 15: ball; 16: steering motor; 17: connecting plate; 18: first hydraulic cylinder; 2: balance steering device; 20: cylinder; 21: curved plate; 22: end cover; 23: weight; 231: distance sensor; 232: infrared proximity sensor; 24: second hydraulic cylinder; 25: controller; 26: baffle; 27: bearing; 28: rotating shaft; 29: third hydraulic cylinder; 3: safety seat; 31: back plate; 311: connecting shaft; 312: pressure sensor; 32: horizontal plate; 33: bumper; 34: VR helmet.

### DETAILED DESCRIPTION

The invention is illustrated in accordance with figures. The figures as simplified diagrams demonstrate the basic structures of the apparatus of embodiments of the invention. Thus; the invention is not limited to the figures.

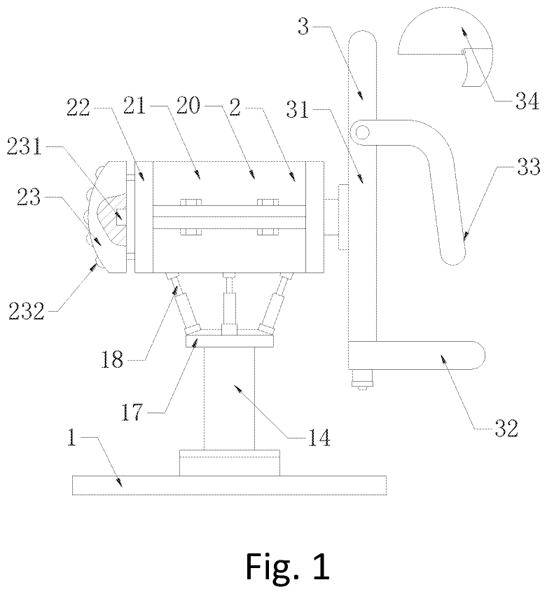

As shown in FIG. 1, a virtual reality high-altitude flight experience device with centrifugal weight system includes a base 1, a balance steering device 2 and a safety seat 3.

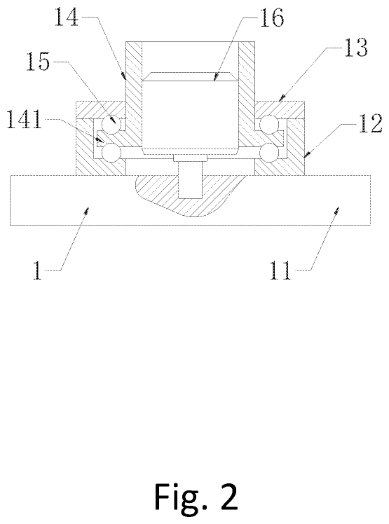

As shown in FIGS. 1, 2 and 4, the base 1 includes a bottom plate 11, a steering seat 12, an annular cover plate 13 and a steering rod 14. The steering seat 12 is a hollow structure with a bidirectional opening, and the opening of the steering seat 12 facing downward is fixedly connected to the bottom plate 11. The opening of the steering seat 12 facing upward is fixedly connected to the annular cover plate 13.

The steering rod 14 has a hollow structure. The lower end of the steering rod 14 passes through a ring in the middle portion of the annular cover plate 13 and is provided with a convex ring 141 laterally extended. In one example embodiment, the convex ring 141 and the steering rod 14 are of a unitary structure. In another example embodiment, the convex ring 141 is welded by the ring and the steering rod 14. The steering rod is engaged with the annular cover plate 13.

The convex ring 141, the steering seat 12 and the annular cover plate 13 are respectively provided with semi-circular grooves (not shown). Balls 15 are disposed on the semi-circular grooves. In other words, the upper and lower end surfaces of the convex ring 141 and the bottom surface of the inner cavity of the steering seat 12 facing the vertical direction of the two end surfaces, and the lower end surface of the annular cover plate 13 are respectively provided with a semi-circular groove. The semi-circular groove on the upper end surface of the convex ring 141 is aligned with the semi-circular groove on the lower end surface of the annular cover plate 13, and balls are provided therebetween. The semi-circular groove on the lower end surface of the convex ring 141 is aligned with the semi-circular groove on the bottom surface of the inner cavity of the steering seat 12, and balls 15 are provided therebetween. The annular side of the convex ring 141 is engaged with the inner wall surface of the steering seat 12.

A steering motor 16 is arranged in the inner cavity of the steering rod 14, and an output shaft of the steering motor 16 is fixedly connected to the bottom plate 11. A connecting plate 17 is fixedly arranged on the upper end of the steering rod 14, and a plurality of first hydraulic cylinders 18 are hingedly disposed on the connecting plate 17.

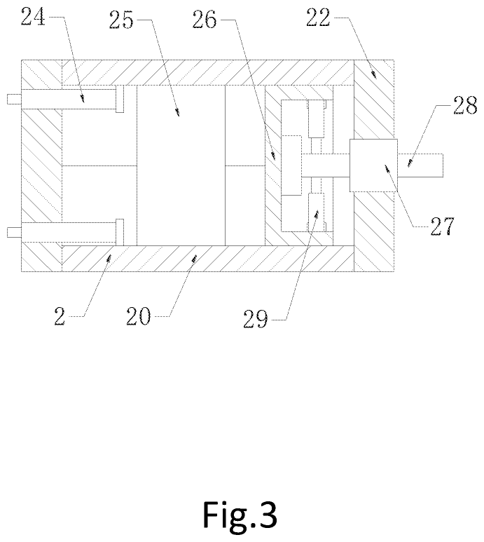

As shown in FIGS. 1, 3, 4, and 5, the balance steering device 2 includes a cylinder 20 composed of two curved plates 21. The cylinder 20 is connected to the steering rod 14 through the first hydraulic cylinder 18. Two ends of the cylinder 20 are respectively fixedly connected to and provided with an end cover 22. One end of the inner cavity of the cylinder 20 is provided with a plurality of second hydraulic cylinders 24 along the axial direction of the cylinder 20. The output end of the second hydraulic cylinder 24 passes through the end cover 22 and is connected to the weight 23. The end which is not the output end of the second hydraulic cylinder 24 is fixedly disposed in the inner cavity of the cylinder 20.

The other end of the inner cavity of the cylinder 20 is fixedly provided with a baffle 26. The baffle 26 and the end cover 22 at this end are provided with bearings 27 rotatably connected with a rotating shaft 28. In other words, one end of the rotating shaft 28 is connected to the bearing 27, and the other end of the rotating shaft 28 extends out of the cylinder 20. The rotating shaft 28 is connected to the baffle 26 by a plurality of third hydraulic cylinders 29 which are radially arranged along the rotating shaft 28 and centered on the rotating shaft 28. A controller 25 is arranged in a middle portion of the inner cavity of the cylinder 20.

The first hydraulic cylinders 18, the second hydraulic cylinders 24 and the third hydraulic cylinders 29 are respectively connected to a device for controlling the hydraulic cylinder output such as a hydraulic pump provided in the cylinder 20, and the related device is connected to the controller 25 and subject to its control.

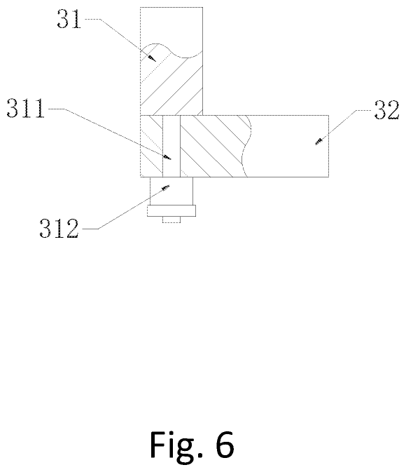

As shown in FIGS. 1 and 6, the safety seat 3 includes a back plate 31, a horizontal plate 32, a bumper 33 and a VR helmet 34. The back plate 31 and the rotating shaft 28 are fixedly connected to each other. The lower end of the back plate 31 is connected to the horizontal plate 32 through a connecting shaft 311, and the bumper 33 is disposed on the back plate 31. The VR helmet 34 should be equipped with a motion sensor for detecting the body position, specifically detecting the movement of the human head. Combined with the current position of the safety seat 3 detected by the motion sensors installed on the back plate 31 and integrated on the controller 25, the VR helmet 34 can obtain and play the picture and sound of the user's viewing position from the controller 25.

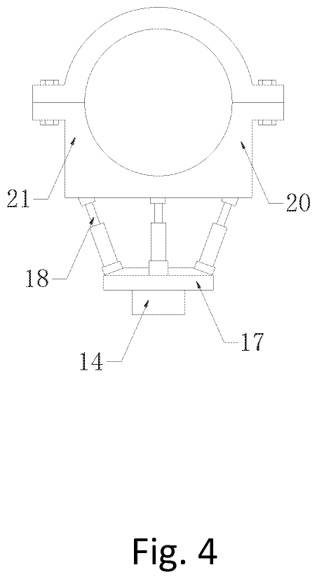

In an example embodiment as shown in FIG. 4, the outside surface of one end of the cylinder 20 facing the steering rod is a plane. The first hydraulic cylinders 18 are respectively connected to points on the plane in two axial directions and in two radial directions of the cylinder 20 to control the swing actions of the cylinder 20 (i.e. swing actions along the axial and radial directions of the cylinder 20, respectively).

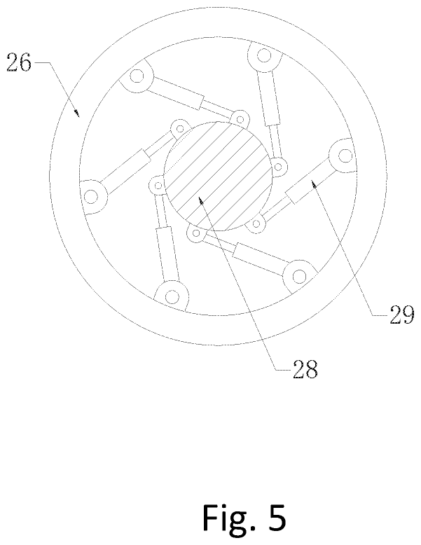

In an example embodiment as shown in FIG. 5, the two ends of the third hydraulic cylinder 29 are respectively hinged with the rotating shaft 28 and the baffle 26, and restrict the movement of the third hydraulic cylinder 29 in the axial direction of the cylinder. The third hydraulic cylinder 29 extends and contracts to drive the rotation of the rotating shaft 28. In order to prevent the third hydraulic cylinder 29 from being unable to rotate the rotating shaft 28, the central axis of the third hydraulic cylinder 29 and the rotating shaft 28 avoid intersections, when the third hydraulic cylinder 29 is connected with the rotating shaft 28. The rotating shaft 28 avoids staying at the position where the intersection is to be made during the rotation of the shaft 28, and the determination of this position is calculated based on the rotation angle of the safety seat 3 detected by the motion sensor provided on the back plate 31, combined with the number of element installations and dimensions, and the like by the preset program in the controller 25.

As shown in FIG. 5, the central axis of the third hydraulic cylinder 29 is located above the central axis of the rotating shaft 28. When the rotating shaft 28 needs to rotate clockwise, the third hydraulic cylinder 29 is directly extended. When the rotating shaft 28 needs to rotate counterclockwise, the third hydraulic cylinder 29 is contracted. When the rotating shaft 28 rotates to the position of the intersection and passes the position by inertia, the third hydraulic cylinder is extended so that the rotating shaft 28 can continue to rotate counterclockwise.

In an example embodiment as shown in FIG. 6, the lower end of the back plate 31 is slidably connected to the horizontal plate 32 through the connecting shaft 311 (i.e. the connecting shaft 311 is engaged with the connecting hole of the horizontal plate 32), and the connecting shaft 311 passes through the horizontal plate 32 and is sleeved with a pressure sensor 312 and fixed by a nut. The pressure applied thereto is detected by the pressure sensor 312. Since it is not directly measured under the human body, it is necessary to convert the weight of the human body.

In an example embodiment as shown in FIG. 1, the weight 23 is provided with a distance sensor 231 for detecting the distance from the end cover 22. Since the weight of the weight 23 is fixed, the weight of both ends of the balance steering device 2 can be balanced by measuring the distance of the extension combined with the body weight data to prevent overturning. The extension and contraction of the weight can provide assistance to the first hydraulic cylinder 18 which controls the swing of the balance steering device 2 in the axis direction of the cylinder 20. An infrared proximity sensor 232 is disposed on the end surface of the weight 23 facing the moving direction of the second hydraulic cylinder 24 to prevent collision when the weight 23 is extended.

The virtual reality high-altitude flight experience device with centrifugal weight system of the present invention includes a base, a balance steering device and a safety seat. The base provides support for the balance steering device and the safety seat, and meanwhile the balance steering device and the safety seat can be rotated along the horizontal plane driven by the steering motor. The first hydraulic cylinder drives the balance steering device to swing, and the third hydraulic cylinder drives the safety seat to rotate on a vertical plane. The safety seat combines the body weight data detected by the pressure sensor during the horizontal plane rotation. The weight disposed on the balance steering device can extend and contract to change the length extending outward to prevent the overturning and the damage to the base caused by centrifugal phenomenon. The VR helmet plays the corresponding picture and sound by detecting the user's position while matching the controller's preset program. It has simple and reasonable structure, easy to operate, low cost, safe and reliable, strong sense of reality, and high degree of intelligence, etc. which effectively solves the problem of poor experience in the existing flight experience devices.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. A virtual reality high-altitude flight experience device with centrifugal weight system, comprising a base 1, a balance steering device 2 and a safety seat 3, wherein the base 1 includes a bottom plate 11, a steering seat 12, an annular cover plate 13 and a steering rod 14; the steering seat 12 is a hollow structure with a bidirectional opening, and the opening of the steering seat 12 facing downward is fixedly connected to the bottom plate 11; the opening of the steering seat 12 facing upward is fixedly connected to the annular cover plate 13,
wherein the steering rod 14 has a hollow structure; the lower end of the steering rod 14 passes through the annular cover plate 13 and is provided with a convex ring 141 laterally extended; the convex ring 14, the steering seat 12 and the annular cover plate 13 are respectively provided with semi-circular grooves; balls are disposed on the semi-circular grooves; a steering motor 16 is arranged in the inner cavity of the steering rod 14, and an output shaft of the steering motor 16 is fixedly connected to the bottom plate 11; a connecting plate 17 is fixedly arranged on the upper end of the steering rod 14, and a plurality of first hydraulic cylinders 18 are hingedly disposed on the connecting plate 17,
wherein the balance steering device 2 includes a cylinder 20 composed of two curved plates 21; the cylinder 20 is connected to the steering rod 14 through the first hydraulic cylinder 18; two ends of the cylinder 20 are respectively fixedly connected to and provided with an end cover 22; one end of the inner cavity of the cylinder 20 is provided with a plurality of second hydraulic cylinders 24 along the axial direction of the cylinder 20; the output end of the second hydraulic cylinder 24 passes through the end cover 22 and is connected to the weight 23,
wherein the other end of the inner cavity of the cylinder 20 is fixedly provided with a baffle 26; the baffle 26 and the end cover 22 at this end are provided with bearings 27 rotatably connected with a rotating shaft 28; the rotating shaft 28 is connected to the baffle 26 by a plurality of third hydraulic cylinders 29 radially arranged; a controller 25 is arranged in a middle portion of the inner cavity of the cylinder 20,
wherein the safety seat 3 includes a back plate 31, a horizontal plate 32, a bumper 33 and a VR helmet 34; the back plate 31 and the rotating shaft 28 are fixedly connected to each other; the lower end of the back plate 31 is connected to the horizontal plate 32 through a connecting shaft 311, and the bumper 33 is disposed on the back plate 31.

2. The virtual reality high-altitude flight experience device with centrifugal weight system of claim 1, wherein the outside surface of one end of the cylinder 20 facing the steering rod is a plane; the first hydraulic cylinders 18 are respectively connected to points on the plane in two axial directions and in two radial directions of the cylinder 20.

3. The virtual reality high-altitude flight experience device with centrifugal weight system of claim 1, wherein the two ends of the third hydraulic cylinder 29 are respectively hinged with the rotating shaft 28 and the baffle 26, and restrict the movement of the third hydraulic cylinder 29 in the axial direction of the cylinder 20.

4. The virtual reality high-altitude flight experience device with centrifugal weight system of claim 1, wherein the lower end of the back plate 31 is slidably connected to the horizontal plate 32 through the connecting shaft 311, and the connecting shaft 311 passes through the horizontal plate 32 and is sleeved with a pressure sensor 312 and fixed by a nut.

5. The virtual reality high-altitude flight experience device with centrifugal weight system of claim 1, wherein the weight 23 is provided with a distance sensor 231 for detecting the distance from the end cover 22, and an infrared proximity sensor 232 is disposed on the end surface of the weight 23 facing the moving direction of the second hydraulic cylinder 24.
